(19) United States
(12) Patent Application Publication
(10) Pub. No.: US 2023/0092931 A1
(43) Pub. Date: Mar. 23, 2023

(54) OMNIDIRECTIONAL LIGHT-EMITTING LIGHT BULB SHELL AND LIGHT BULB HAVING THE SAME

(71) Applicant: Hangzhou SIJUNSI Technology Co., Ltd., Hangzhou (CN)

(72) Inventor: Tiehan GE, Hangzhou (CH)

(21) Appl. No.: 17/904,027

(22) PCT Filed: Feb. 8, 2021
(86) PCT No.: PCT/CN2021/075911

§ 371 Date: Aug. 11, 2022

(30) Foreign Application Priority Data
Feb. 11, 2020 (CN) 202010086681.3

(51) Int. Cl. F21K 9/232; F21K 9/237; F21V 29/503; F21V 29/83

(52) U.S. Cl. CPC F21K 9/232; F21K 9/237; F21V 29/503; F21V 29/83; F21Y 2115/10

(57) ABSTRACT

An omnidirectional light-emitting bulb shell and a light bulb having the same, comprising a light-transmitting bulb shell, wherein, the light-transmitting bulb shell forms an enclosed space, at least one heat dissipation channel is arranged through the light-transmitting bulb shell, two ends of the heat dissipation channel are communicated with outside of the bulb shell respectively, and at least one LED filament is arranged in the enclosed space on the surface of at least part of the heat dissipation channels that is within the enclosed space. The bulb shell and the light bulb having the same can implements 360 degree omnidirectional illumination with large light-emitting angle and high light-emitting efficiency, and have good heat dissipation performance, thereby increasing the service life of the LED lamp.

### TECHNICAL FIELD

The present disclosure relates to a light bulb shell and a light bulb having the same, in particular to an omnidirectional light-emitting light bulb shell and a light bulb having the same.

### BACKGROUND

In recent years, various performance of the illuminating LED lamp has been improved considerably due to the continuous development of the LED technology. The LED light has become the trend in the future of the light source since it has a number of advantages such as long lifetime, high luminous efficiency, no UV radiation and lower energy consumption.

However, unlike the incandescent lamp and the like which could implement 360 degree omnidirectional illumination, the LED light source has directivity, so its illuminating effect, to a certain extent, is impacted when it replaces the traditional light source such as the incandescent lamp and the like. Especially when the LED is made into a traditional tube-shaped daylight lamp. As disclosed in Chinese Patent CN102022651A, the LED daylight lamp comprises a bulb shell, LED light source components, an LED driving component, two end caps and a heat dissipating housing. The bulb shell is connected to the heat dissipating housing, and the two end caps cover the bulb shell and the heat dissipating housing which have been connected at their two ends respectively. The cross sections of the bulb shell and the heat dissipating housing are both arc-shaped, and the bulb shell and the heat dissipating housing form a cavity in which the LED light source components and the LED driving component are located. In this LED daylight lamp, the LEDs have to be arranged within a plane so as to meet the requirements for their heat dissipation. Thus, its light emitting area could merely cover 180-degree rather than 360-degree (i.e., it emits light from a plane), although it has a long straight tube-shape like the traditional daylight lamp. Therefore, in the current LED lamps, the heat dissipation area and the light-emitting area are contradictory. Therefore, the existing LED lamps cannot realize 360-degree light emission while meeting the heat dissipation requirements.

### SUMMARY

The present application aims to provide a light bulb and a bulb shell which could implement omnidirectional illumination as well as has good heat dissipation performance.

In order to solve the technical problem mentioned above, the present application provides technical solutions as follows. An omnidirectional light-emitting bulb shell, comprising a light-transmitting bulb shell, wherein, the light-transmitting bulb shell forms an enclosed space, at least one heat dissipation arranged through the light-transmitting bulb shell, two ends of the heat dissipation channel are communicated with outside of the bulb shell respectively, and at least one LED filament is arranged in the enclosed space on the surface of at least part of the heat dissipation channels that is within the enclosed space.

Preferably, a heat sink is fixed on a side of the heat dissipation channel that communicates with the outside of the bulb shell.

Preferably, an exhaust pipe is provided in the heat dissipation channel of the light-transmitting bulb shell, one end of the exhaust pipe is connected to outside of the heat dissipation channel, the other end of the exhaust pipe is connected to the enclosed space, the exhaust pipe is used to evacuate the enclosed space or fill the enclosed space with gas during fabricating the light bulb, and the exhaust pipe is sealed after fabricating the light bulb.

Preferably, the light-transmitting bulb shell has a hollow cylindrical structure, the heat dissipation channel extends in the light-transmitting bulb shell along the same direction as the hollow cylindrical structure and is spaced from the hollow cylindrical structure, and both ends of the heat dissipation channel are melted together with the light-transmitting bulb shell so as to form the enclosed space.

Preferably, one end of the light-transmitting bulb shell is connected to the lamp cap, and the other end of the light-transmitting bulb shell is connected to a connecting member; or both ends of the light-transmitting bulb shell are respectively connected to a connecting member, which has two ends that can be respectively connected to different light-transmitting bulb shells.

Preferably, there are at least two heat dissipation channels in the light-transmitting bulb shell, and the LED filament is arranged on the surface of at least one heat dissipation channels that is within the enclosed space.

Preferably, there are four heat dissipation channels in the light-transmitting bulb shell; one heat dissipation channel is located in the center of the bulb shell and extends vertically; and other three heat dissipation channels have curved shape, evenly distributed in the peripheral region of the light-transmitting bulb shell and extend up and down.

Preferably, the LED filament is wound on a surface of the heat dissipation channel; or the LED filament is arranged at intervals or crosswise along a surface of the heat dissipation channel.

A light bulb comprising the omnidirectional light-emitting bulb shell as mentioned above, comprising a lamp cap and a driver within the lamp cap, wherein, one end of the light-transmitting bulb shell is fixedly connected to the lamp cap, and the LED filament is electrically connected to the driver within the lamp cap via a lead wire penetrating the light-transmitting bulb shell.

Preferably, one end of the light-transmitting bulb shell is connected to a connector, and thus connected to the lamp cap by the connector; a plurality of ventilation holes are provided on the peripheral surface of the connector; and the heat dissipation channel communicates with the outside through the ventilation holes.

Compared with the prior art, the light bulb shell and the light bulb having the same according to the present application could implements 360 degree omnidirectional illumination with large light-emitting angle and high light-emitting efficiency, and have good heat dissipation performance, thereby increasing the service life of the LED lamp. Additionally, the translucent bulb shell of the LED light could be combined into a bulb shell with various lengths or various shapes as required, and its processing is facilitated, thereby widening the range of applications of the LED light.

### BRIEF DESCRIPTION OF THE DRAWINGS

FIG. 1 is a perspective view of the LED bulb according to the first embodiment of the present invention;

FIG. 2 is a sectional view of the LED bulb according to the first embodiment of the present invention;

FIG. 3 is a perspective view of the LED bulb according to the second embodiment of the present invention;

FIG. 4 is a sectional view of the LED bulb according to the second embodiment of the present invention;

FIG. 5 is a sectional view of the LED bulb according to the third embodiment of the present invention; and

FIG. 6 schematically shows a structure of the bulb according to the fourth embodiment of the present invention.

### DETAILED DESCRIPTION OF EMBODIMENTS

Hereinafter, embodiments of the present disclosure will be described in detail with reference to the drawings. Examples of the embodiments are shown in the accompanying drawings, wherein the same or similar reference numerals represent the same or similar elements or the elements having the same or similar functions throughout. The embodiments described below with reference to the drawings are exemplary, which are intended to explain the disclosure, but should not be considered as limiting the present disclosure.

The terms “first” and “second” are used for descriptive purposes only and are not to be considered as indicating or implying a relative importance or implicitly indicating the number of the referred technical features. Thus, features defined by “first” and “second” may comprise one or more of the features either explicitly or implicitly. In the description of the present disclosure, the meaning of “a plurality” is two or more unless specifically defined otherwise.

In the present disclosure, it noted that the terms “installation”, “connection”, “connected” and “fix” should be understood in a broad sense unless explicitly stated and limited otherwise. For example, it may be fixed connection, removable connection or integral connection. It can be a mechanical connection or an electrical connection; it can be a direct connection or an indirect connection through an intermediate medium; and it can be the internal communication between two elements or the interaction relationship between two elements. For those of ordinary skill in the art, the specific meanings of the above terms in the present disclosure may be understood on a case-by-case basis.

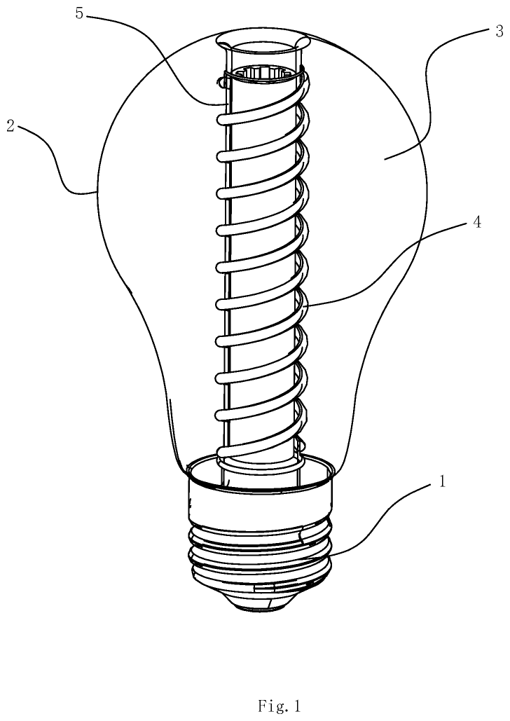

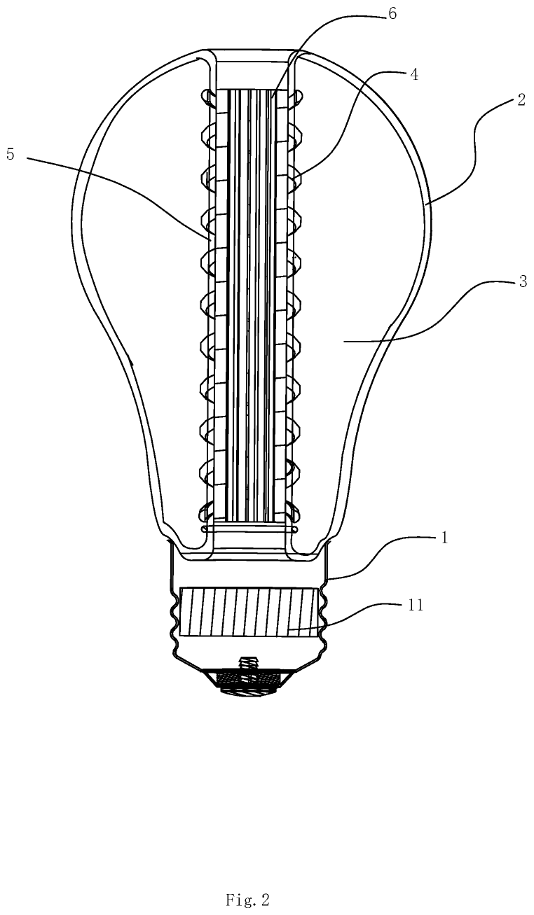

As shown in FIGS. 1-2, the light bulb according to the first embodiment of the present application includes a lamp cap 1 and a light-transmitting bulb shell 2 connected to the lamp cap 1. A driver 11 is provided in the lamp cap 1. The driver 11 has a positive lead wire and a negative lead wire, which are connected to the lamp cap 1. The lamp cap 1 is electrically connected to the outside through the thread at its bottom.

The light-transmitting bulb shell 2 forms an enclosed space 3. An LED filament 4 is arranged in the enclosed space 3. At least one channel penetrates through the center of the light-transmitting bulb shell 2. The channel acts as a heat dissipation channel 5. The heat dissipation channel 5 is in communication with the outside at its two ends. As shown in FIGS. 1-2, the number of the heat dissipation channel 5 may be one, which is located in the center of the light-transmitting bulb shell 2. The heat dissipation channel 5 extends up and down, and the enclosed space 3 is an annular space around the heat dissipation channel 5. The LED filament 4 is spirally wound on the surface of the heat dissipation channel 5 that is inside the enclosed space 3 and extends spirally along the heat dissipation channel 5, so that it can provide multi-angle and omnidirectional illumination. In this embodiment, the light-transmitting bulb shell 2 is an annular closed space, the bottom end of which is directly inserted and connected to the lamp cap 1.

The LED filament 4 includes a substrate and an LED light-emitting element arranged on the substrate. The substrate may be made of transparent material such as glass, ceramics, plastic, etc., or opaque material such as metal. The surface of the substrate on which the LED light-emitting element is provided is coated with a phosphor layer, transparent protective glue, light diffusion or reflection layer and so on.

The above-mentioned LED light-emitting element may be an LED chip, or a surface mount light-emitting diode (SMD LED). Alternatively, the LED light-emitting element may be directly formed on the substrate through processes such as coating powder, die bonding, and wire bonding. The LED light-emitting element can be in various forms.

Both ends of the substrate are connected with lead wires 43, and are connected to the driver 11 through the lead wires 43. The lead wires 43 pass through the light-transmitting bulb shell 2 and are electrically connected to the driver 11 in the lamp cap 1.

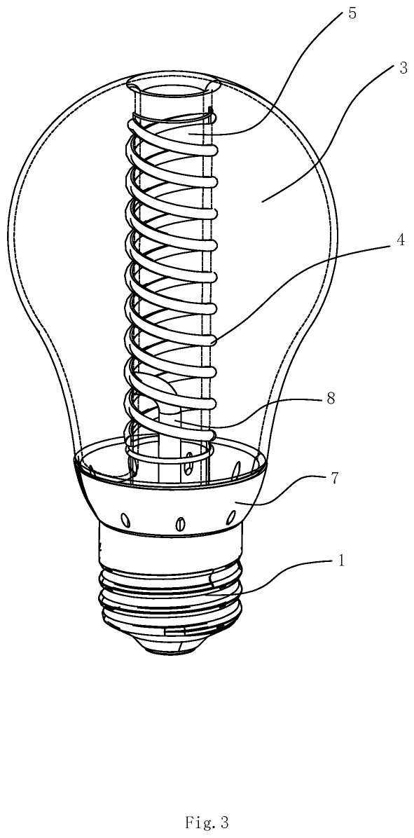

Both ends of the substrate are connected with lead wires 43, and are connected to the driver 11 through the lead wires 43. An electrical connection circuit is preset on the substrate, which electrically connect the lead wire 43 and the LED light-emitting element, so as to supply power to the LED light-emitting element. Alternatively, the electrical connection circuit may be connected to the LED light-emitting element and the lead wire 43 before fixedly connected to the substrate and packaged. As shown in FIG. 3, there are two lead wires 43. One of them is connected to the end of the substrate 41 that is next to the bottom of the light-transmitting bulb shell 2. The other one extends to the top of the heat dissipation channel 5 and is connected to the end of the substrate that is next to the top of the heat dissipation channel 5. The bottom end of the lead wires 43 penetrate through the light-transmitting bulb shell 2 and then are inserted into the lamp cap 1 and connected to the driver 11 in the lamp cap 1.

The heat dissipation channel 5 is made of the same material as the light-transmitting bulb shell 2 and is integrally formed. That is, a through heat dissipation channel is provided in the bulb when the bulb is fired. The structure of the heat dissipation channel may be various forms. For example, it may be a hollow straight cylinder as shown in FIGS. 1-2, or it may be a curved channel or an annular channel, and so on. The surface of the heat dissipation channel 5 that is located inside the enclosed space 3 is wound with an LED filament 4.

In this embodiment, a heat sink 6 is fixed on the inner side of the heat dissipation channel 5, i.e., the side that communicates with the outside. The air in the light-transmitting bulb shell 2 communicates with the outside through the heat dissipation channel 5, and in the heat dissipation channel 5, flows through the heat sink 6 for heat dissipation. The air convection dissipates the heat from the LED filament 4. With the aid of the heat sink 6, better heat dissipation may be realized. The heat sinks can be spaced or continuously arranged on the surface of the heat dissipation channel 5. The heat sink can also has a hollow cylindrical body that is integrally formed and matched with the heat dissipation channel 5. The surface of the heat sink 6 is provided with a plurality of fins. The fins have a regular or irregular concave and convex surface, so as to increase the heat dissipation area.

Moreover, those skilled in the art can understand that the LED filaments in this embodiment are wound and arranged along the surface of the heat dissipation channel 5. In other embodiment, they may be arranged in parallel at intervals on the surface of the heat dissipation channel 5 that is inside the enclosed space, extending horizontally, vertically or even obliquely. The LED filaments can also be cross-arranged along the surface of the heat dissipation channel, as long as the LED filaments are arranged on the surface of the heat dissipation channel. Those skilled in the art can also understand that the LED light-emitting elements can also be directly arranged on the surface of the heat dissipation channel 5, electrically connected through the connecting wires on the surface of the heat dissipation channel 5, with the substrate in the LED filament omitted.

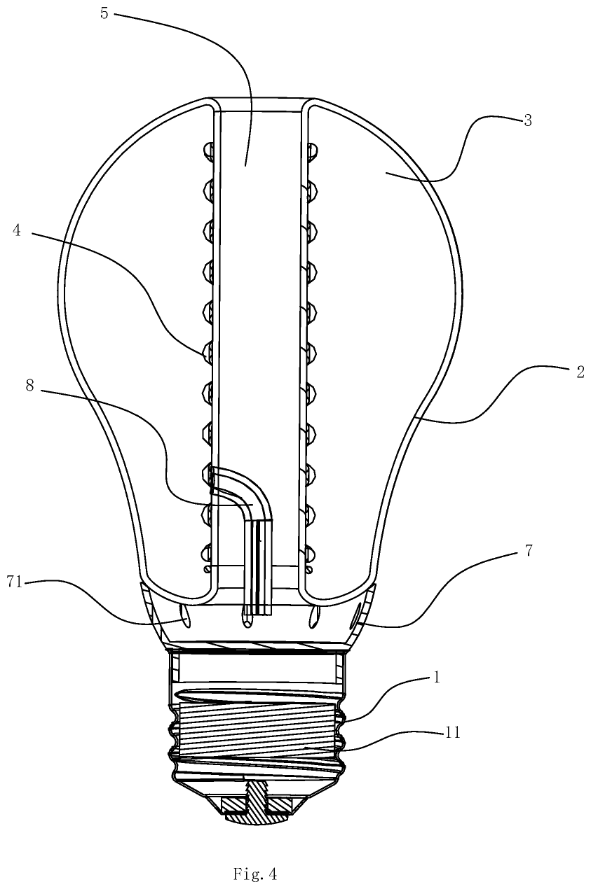

FIGS. 3 and 4 show the second embodiment of the present application. The structure of the second embodiment is almost the same as the first embodiment, and the difference lies in that the bottom end of the light-transmitting bulb shell 2 is connected to a connector 7. The bulb shell 2 is connected to the lamp cap 1 via the connector 7. In the first embodiment, the bottom end of the light-transmitting bulb shell 1 is directly connected to the lamp cap 1. That is to say, one end of the heat dissipation channel 5 is directly connected to the lamp cap 1 and thus not communicated with the outside. However, in the second embodiment, the bottom end of the light-transmitting bulb shell 1 is connected to the connector 7, and the bottom end of the connector 7 is connected to the lamp cap 1. A plurality of ventilation holes 71 may be provided on the peripheral surface of the connector 7, and the ventilation holes 71 communicate with the heat dissipation channel 5 in the light-transmitting bulb shell 1, which make the other end of the heat dissipation channel 5 communicated to the outside. That will create a stronger chimney effect. It is more conducive to air circulation and convection heat dissipation.

Moreover, in this embodiment, the position of the heat dissipation channel 5 is provided with an exhaust pipe 8. One end of the exhaust pipe 8 is connected to the outside of the heat dissipation channel 5, and the other end is connected to the enclosed space 3. The exhaust pipe 8 is used to evacuate the enclosed space 3 or fill the enclosed space 3 with the gas that can facilitate heat dissipation as required, during fabricating the light bulb. After the bulb is fabricated, the exhaust pipe 8 can be sealed.

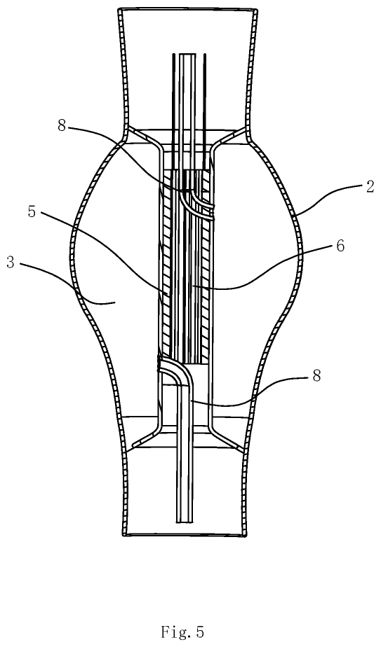

FIG. 5 shows the third embodiment of the present application. In this embodiment, the light-transmitting bulb shell 2 has a hollow cylindrical structure, with a channel extending in the same direction and spaced from the hollow cylindrical structure is provided therein. This channel acts as the heat dissipation channel 5. Both ends of the heat dissipation channel 5 are melted together with the light-transmitting bulb shell 2. That is, an enclosed space 3 is formed in the light-transmitting bulb shell 2. The heat dissipation channel 5 is provided with an exhaust pipe 8. One end of the exhaust pipe 8 is connected to the outside of the heat dissipation channel 5, and the other end is connected to the enclosed space 3. The exhaust pipe 8 is used to evacuate the enclosed space 3 or fill the enclosed space 3 with the gas that can facilitate heat dissipation, during fabricating the light bulb. After the bulb is fabricated, the exhaust pipe 8 can be sealed. The structure of the light-transmitting bulb shell 2 can be formed in various shapes. For example, the light-transmitting bulb shell 2 may have an opening at least at one end. Alternatively, the light-transmitting bulb shell 2 may have openings at both ends, and the two ends of the heat dissipation channel 5 are respectively melted with the inner surface of the light-transmitting bulb shell, thereby forming enclosed space 3 and a heat dissipation channel 5 communicating with the outside. In the enclosed space 3, an LED filament 4 is wound and arranged on the surface of the heat dissipation channel 5. Thus, it provides bulbs with different structures and shapes, as well as omnidirectional and multi-angle lighting.

In this embodiment, one end of the light-transmitting bulb shell may be connected to the lamp cap and one end may be open. Alternatively, the two ends may be respectively connected to a connecting member, which has two ends that can be respectively connected to different light-transmitting bulb shells. In this way, multiple bulb shells may be connected to form a long bulb shell form.

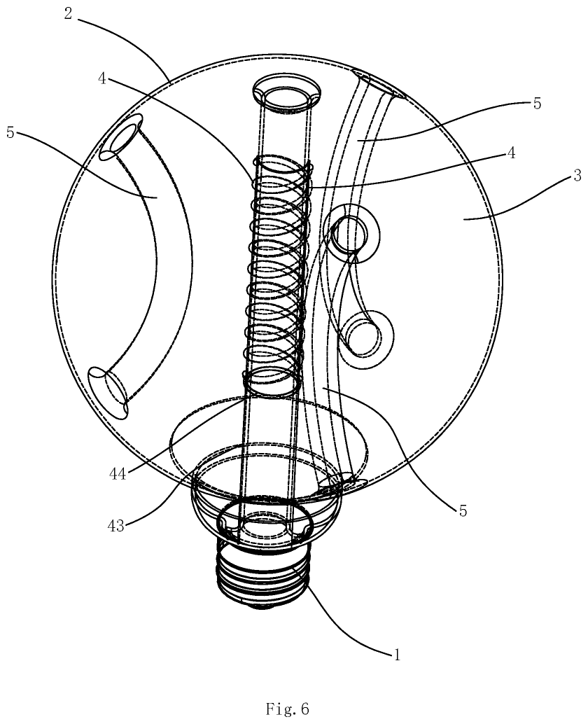

FIG. 6 shows the light bulb according to the fourth embodiment, the structure of this embodiment is almost the same as the prior three embodiments, which includes a lamp cap 1 and a light-transmitting bulb shell 2 connected to the lamp cap 1. A driver is provided in the lamp cap 1. The driver has a positive lead wire and a negative lead wire, which are connected to the lamp cap 1. The lamp cap 1 is electrically connected to the outside through the thread at its bottom.

The light-transmitting bulb shell 2 forms an enclosed space 3. An LED filament 4 is arranged in the enclosed space 3. Four channels penetrate through the center of the light-transmitting bulb shell 2. The four channels act as heat dissipation channels 5. The heat dissipation channels 5 are in communication with the outside at their two ends. As shown in FIG. 6, one heat dissipation channel 5 is positioned in the center of the light-transmitting bulb shell 2, extending up and down. The other three heat dissipation channels 5 have curved shape, and are evenly distributed in the light-transmitting bulb shell 2 around the central heat-dissipating channel 5. The LED filament 4 is spirally wound on the surface of the heat dissipation channel 5 that is inside the enclosed space 3 and extends spirally along the heat dissipation channel 5, so that it can provide multi-angle and Omnidirectional illumination. In this embodiment, the light-transmitting bulb shell 2 is an annular closed space, the bottom end of which is directly inserted and connected to the lamp cap 1. In this embodiment, there are two LED filaments, which are wound in parallel on the surface of the central heat dissipation channel.

The LED filament 4 includes a substrate and an LED light-emitting element arranged on the substrate. The substrate may be made of transparent material such as glass, ceramics, plastic, etc., or opaque material such as metal. The surface of the substrate on which the LED light-emitting elements are provided is coated with a phosphor layer, transparent protective glue, light diffusion or reflection layer and so on.

The above-mentioned LED light-emitting element may be an LED chip, or a surface mount light-emitting diode (SMD LED). Alternatively, the LED light-emitting element may be directly formed on the substrate through processes such as coating powder, die bonding, and wire bonding. The LED light-emitting element can be in various forms.

There are two lead wires 43, which are respectively connected to the driver 11. The lead wires 43 pass through the light-transmitting bulb shell 2 and are electrically connected to the driver 11 in the lamp cap 1. The two lead wires are respectively connected to the connecting rings 44 arranged around the surface of the heat dissipation channel, and thus connected to both ends of the LED filament 4 through the connecting rings 44. There are two connecting rings 44. One of them is located on the top of the heat dissipation channel, for connecting the upper end of the LED filament 4. The other one is located on the bottom of the heat dissipation channel, for connecting the lower end of the LED filament 4. As shown in FIG. 6, one lead wire 43 is connected to the end of the substrate 41 that is next to the bottom of the light-transmitting bulb shell 2. The other lead wire 43 extends to the top of the heat dissipation channel 5 and is connected to the end of the substrate that is next to the top of the heat dissipation channel 5. The bottom end of the lead wires 43 penetrate through the light-transmitting bulb shell 2 and then are inserted into the lamp cap 1 and connected to the driver 11 in the lamp cap 1.

In this embodiment, only one heat dissipation channel 5 is wound with LED filaments on its surface. Those skilled in the art can also understand that, it is also possible that some of the heat dissipation channel 5 or even all of them are wound with LED filaments on their surface.

In addition, those skilled in the art can understand that the enclosed space can also be separated into multiple independent enclosed spaces. The multiple independent enclosed spaces are separated by multiple heat dissipation channels. Alternatively, there may be only one enclosed space, and multiple heat dissipation channels are arranged therein.

The above-mentioned omnidirectional light-emitting LED bulb shell and the light bulb with the bulb shell provide heat dissipation channels to dissipate heat from the LED light-emitting elements in the light bulb, and the LED light-emitting elements are located in the enclosed space, which can be filled with gas so as to protect the LED light-emitting elements and improve brightness and illumination effect. In addition, multiple bulb shells can be connected together to form a shape as required. In addition, the bulb shell and the light bulb can facilitate the arrangement of LED light-emitting elements that emit light in multiple directions and angles, so that the light-emitting angles are more omnidirectional and three-dimensional.

Although the preferred embodiments of the present invention have been described above in detail, the person skilled in the art should clearly understand that various modification and alteration to the present invention are possible. Any modification, equivalent replacement and improvement within the spirits and principles of the present invention all fall into the protection scope of the present invention.

1. An omnidirectional light-emitting bulb shell, comprising a light-transmitting bulb shell, wherein,
the light-transmitting bulb shell forms an enclosed space;
at least one heat dissipation channel is arranged through the light-transmitting bulb shell;
two ends of the heat dissipation channel are communicated with outside of the bulb shell respectively; and
at least one LED filament is arranged in the enclosed space on the surface of at least part of the heat dissipation channels that is within the enclosed space.

2. The omnidirectional light-emitting bulb shell according to claim 1, wherein, a heat sink is fixed on a side of the heat dissipation channel that communicates with the outside of the bulb shell.

3. The omnidirectional light-emitting bulb shell according to claim 1, wherein,
an exhaust pipe is provided in the heat dissipation channel of the light-transmitting bulb shell;
one end of the exhaust pipe is connected to outside of the heat dissipation channel;
the other end of the exhaust pipe is connected to the enclosed space;
the exhaust pipe is used to evacuate the enclosed space or fill the enclosed space with gas during fabricating the light bulb; and
the exhaust pipe is sealed after fabricating the light bulb.

4. The omnidirectional light-emitting bulb shell according to claim 1, wherein,
the light-transmitting bulb shell has a hollow cylindrical structure;
the heat dissipation channel extends in the light-transmitting bulb shell along the same direction as the hollow cylindrical structure and is spaced from the hollow cylindrical structure; and
both ends of the heat dissipation channel are melted together with the light-transmitting bulb shell so as to form the enclosed space.

5. The omnidirectional light-emitting bulb shell according to claim 1, wherein,
one end of the light-transmitting bulb shell is connected to the lamp cap; and
the other end of the light-transmitting bulb shell is connected to a connecting member; or both ends of the light-transmitting bulb shell are respectively connected to a connecting member, which has two ends that can be respectively connected to different light-transmitting bulb shells.

6. The omnidirectional light-emitting bulb shell according to claim 1, wherein,
there are at least two heat dissipation channels in the light-transmitting bulb shell; and
the LED filament is arranged on the surface of at least one heat dissipation channels that is within the enclosed space.

7. The omnidirectional light-emitting bulb shell according to claim 6, wherein,
there are four heat dissipation channels in the light-transmitting bulb shell;
one heat dissipation channel is located in the center of the bulb shell and extends vertically; and
other three heat dissipation channels have curved shape, evenly distributed in the peripheral region of the light-transmitting bulb shell and extend up and down.

8. The omnidirectional light-emitting bulb shell according to claim 7, wherein,
the LED filament is wound on a surface of the heat dissipation channel; or
the LED filament is arranged at intervals or crosswise along a surface of the heat dissipation channel.

9. A light bulb comprising an omnidirectional light-emitting bulb shell, a lamp cap and a driver within the lamp cap, wherein,
the omnidirectional light-emitting bulb shell comprising a light-transmitting bulb shell,
the light-transmitting bulb shell forms an enclosed space,
at least one heat dissipation channel is arranged through the light-transmitting bulb shell; two ends of the heat dissipation channel are communicated with outside of the bulb shell respectively; and
at least one LED filament is arranged in the enclosed space on the surface of at least part of the heat dissipation channels that is within the enclosed space
one end of the light-transmitting bulb shell is fixedly connected to the lamp cap; and
an LED filament is electrically connected to the driver within the lamp cap via a lead wire penetrating the light-transmitting bulb shell.

10. The light bulb according to claim 9, wherein,
one end of the light-transmitting bulb shell is connected to a connector, and thus connected to the lamp cap by the connector;
a plurality of ventilation holes are provided on the peripheral surface of the connector; and
the heat dissipation channel communicates with the outside through the ventilation holes.

11. The light bulb according to claim 9, wherein,
a heat sink is fixed on a side of the heat dissipation channel that communicates with the outside of the bulb shell.

12. The light bulb according to claim 9, wherein,
an exhaust pipe is provided in the heat dissipation channel of the light-transmitting bulb shell;
one end of the exhaust pipe is connected to outside of the heat dissipation channel;
the other end of the exhaust pipe is connected to the enclosed space;
the exhaust pipe is used to evacuate the enclosed space or fill the enclosed space with gas during fabricating the light bulb; and
the exhaust pipe is sealed after fabricating the light bulb.

13. The light bulb according to claim 9, wherein,
the light-transmitting bulb shell has a hollow cylindrical structure;
the heat dissipation channel extends in the light-transmitting bulb shell along the same direction as the hollow cylindrical structure and is spaced from the hollow cylindrical structure; and
both ends of the heat dissipation channel are melted together with the light-transmitting bulb shell so as to form the enclosed space.

14. The light bulb according to claim 9, wherein,
there are at least two heat dissipation channels in the light-transmitting bulb shell; and
the LED filament is arranged on the surface of at least one heat dissipation channels that is within the enclosed space.

15. The light bulb according to claim 14, wherein,
there are four heat dissipation channels in the light-transmitting bulb shell;
one heat dissipation channel is located in the center of the bulb shell and extends vertically; and
other three heat dissipation channels have curved shape, evenly distributed in the peripheral region of the light-transmitting bulb shell and extend up and down.

16. The light bulb according to claim 15, wherein,
the LED filament is wound on a surface of the heat dissipation channel; or
the LED filament is arranged at intervals or crosswise along a surface of the heat dissipation channel.
